(19) United States
(12) Patent Application Publication
(10) Pub. No.: US 2023/0016037 A1
(43) Pub. Date: Jan. 19, 2023

(54) SYSTEMS AND METHODS FOR MULTIMODAL SENSOR FUSION IN CONNECTED LIGHTING SYSTEMS USING AUTOENCODER NEURAL NETWORKS FOR OCCUPANT COUNTING

(71) Applicant: SIGNIFY HOLDING B.V., EINDHOVEN (NL)

(72) Inventors: Abhishek MURTHY, CAMBRIDGE, MA (US); Ramin MOHAMMADI, CAMBRIDGE, MA (US)

(21) Appl. No.: 17/787,400

(22) PCT Filed: Dec. 11, 2020
(86) PCT No.: PCT/EP2020/085812

§ 371 Date: Jun. 20, 2022

Related U.S. Application Data
(60) Provisional application No. 62/954,521, filed on Dec. 29, 2019.

(30) Foreign Application Priority Data
Jan. 20, 2020 (EP) 20152636.5

(51) Int. Cl. H05B 47/125; H05B 47/13; G06N 20/20

(52) U.S. Cl. CPC H05B 47/125; H05B 47/13; G06N 20/20

(57) ABSTRACT

A system for determining an occupancy of an environment is provided. The system may include an image sensor, a motion sensor, and a controller in communication with the image sensor and the motion sensor. The controller may be configured to generate an encoded image representation by encoding the image signal based on an autoencoder. The controller may be further configured to generate an encoded motion representation by encoding the motion signal based on the autoencoder. The controller may be further configured to train the autoencoder with the image signal and/or motion signal. The controller may be further configured to generate a fused representation based on the encoded image representation and the encoded motion representation. The controller may be further configured to determine the occupancy of the environment based on the fused representation. The occupancy of the environment may be determined by applying the fused representation to a machine learning module.

### FIELD OF THE DISCLOSURE

The present disclosure is directed generally to counting occupants in an environment.

### BACKGROUND

A modern open office environment will typically include a plurality of smart luminaires electrically connected via a connected lighting system. These smart luminaires are often equipped with a variety of sensors of different modalities to collect data from the open office environment. Examples of such sensors include passive infrared (PIR) sensors, microwave sensors, thermopiles, temperature sensors, humidity sensors, near field communication sensors, and microphones. Various combinations of these sensors may be activated to capture data required for different use cases. A simple use case, such as presence detection, may only utilize a single type of sensor. However, a more complex use case, such as people counting, may utilize multiple modalities of data collected by multiple sensors.

Processing the multimodal sensor data captured by the sensor bundles is a crucial step of implementing the use cases. Further, the captured multimodal sensor data must be combined and processed in the context of computational and communication limitations of the connected lighting system. Accordingly, enabling more complex use cases requires the processing of additional data captured by the newly-activated sensors. In a typical “stove-piped” approach, each sensor and use case requires a different algorithm. This stove-piped approach may lead to processing redundancy. Further, considering system limitations, this approach may not be feasible when applied to large neural networks requiring large amounts of data for training. Accordingly, there is a need for a system for processing multimodal sensor data within the communication and computational constraints of a typical connected lighting system.

### SUMMARY OF THE DISCLOSURE

The present disclosure is directed to inventive systems and methods for counting occupants in an environment, such as an office space, based on an autoencoder neural network. The autoencoder fuses data collected by imaging modalities, such as multi pixel thermopile (MPT) arrays or cameras, with motion modalities, such as passive infrared (PIR) sensors. Fusing the multimodal data using the autoencoder obviates the need for the stove-piping approaches described above. Further, computational and communication costs of handling and processing the large amounts of complex data produced by the multimodal sensor bundles are mitigated by generating a compressed representation of the collected data. As a result, the systems and methods of the present disclosure are scalable to complex use cases using several sensor modalities.

Generally, in one aspect, a system for determining an occupancy of an environment is provided. The system may include one or more image sensors. The image sensors may be configured to generate an image signal. At least one of the image sensors may be an MPT array. At least one of the image sensors may be a camera.

The system may include one or more motion sensors. The motion sensors may be configured to generate a motion signal. At least one of the motion sensors may be a passive PIR sensor.

The system may include a controller. The controller may be in communication with the image sensor and the motion sensor. The controller may be configured to generate an encoded image representation by encoding the image signal based on an autoencoder.

The controller may be further configured to generate an encoded motion representation by encoding the motion signal based on the autoencoder.

The controller may be further configured to train the autoencoder with the image signal and/or motion signal.

The controller may be further configured to generate a fused representation based on the encoded image representation and the encoded motion representation. In one example, the controller may be further configured to generate the fused representation by concatenating the encoded image representation with the encoded motion representation.

In another example, the controller may be configured to generate the fused representation by generating a concatenated representation by concatenating the encoded image representation with the encoded motion representation, and encoding the concatenated representation based on the autoencoder.

The controller may be further configured to determine the occupancy of the environment based on the fused representation. The occupancy of the environment may be determined by applying the fused representation to a machine learning module. The machine learning module may be a decision tree module.

Generally, in another aspect, a method for determining an occupancy of an environment is provided. The method may include generating, via one or more image sensors, an image signal. The method may further include generating, via one or more motion sensors, a motion signal.

The method may further include generating, via a controller, an encoded image representation by encoding the image signal based on an autoencoder. The method may further include generating, via the controller, an encoded motion representation by encoding the motion signal based on the autoencoder.

The method may further include training, via the controller, the autoencoder with the image signal and/or motion signal.

The method may further include generating, via the controller, a fused representation based on the encoded image representation and the encoded motion representation. In one example, the fused representation may be generated by concatenating, via the controller, the encoded image representation with the encoded motion representation.

In another example, the fused representation may be generated by generating, via the controller, a concatenated representation by concatenating the encoded image representation with the encoded motion representation, and encoding, via the controller, the concatenated representation based on the autoencoder.

The method may further include determining, via the controller, the occupancy of the environment based on the fused representation. The occupancy of the environment may be determined by applying the fused representation to a machine learning module. The machine learning module may be a decision tree module.

In various implementations, a processor or controller may be associated with one or more storage media (generically referred to herein as “memory,” e.g., volatile and non-volatile computer memory such as RAM, PROM, EPROM, and EEPROM, floppy disks, compact disks, optical disks, magnetic tape, etc.). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects as discussed herein. The terms “program” or “computer program” are used herein in a generic sense to refer to any type of computer code (e.g., software or microcode) that can be employed to program one or more processors or controllers.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

These and other aspects of the various embodiments will be apparent from and elucidated with reference to the embodiment(s) described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is a schematic of a system for occupancy counting, in accordance with an example.

FIG. 2 is a further schematic of a system for occupancy counting, in accordance with an example.

FIG. 3 is a first flowchart of a method for occupancy counting, in accordance with an example.

FIG. 4 is a second flowchart of a method for occupancy counting utilizing concatenation, in accordance with an example.

FIG. 5 is a third flowchart of a method for occupancy counting utilizing cascaded encoding, in accordance with an example.

### DETAILED DESCRIPTION OF EMBODIMENTS

The present disclosure is directed to inventive systems and methods for counting occupants in an environment, such as an open office. The systems and methods analyze data collected by image sensors, such as multi pixel thermopile (MPT) arrays, and motion sensors, such as passive infrared (PIR) sensors. Analyzing data collected by two or more different types of sensors provides greater precision in occupancy counting, especially in cases where occupants are sitting relatively still for prolonged periods of time. The disclosed systems and methods encode, or compress, the collected data using an autoencoder. The encoded data is then combined using concatenation and/or cascading encoding. The combined data is then analyzed by a machine learning algorithm, such as a decision tree, to determine the occupancy of the environment. Processing the encoded data, rather than the raw data collected by the sensors, provides significant processing time and power savings. Accordingly, the present inventive systems and methods may be advantageously applied in edge computing systems.

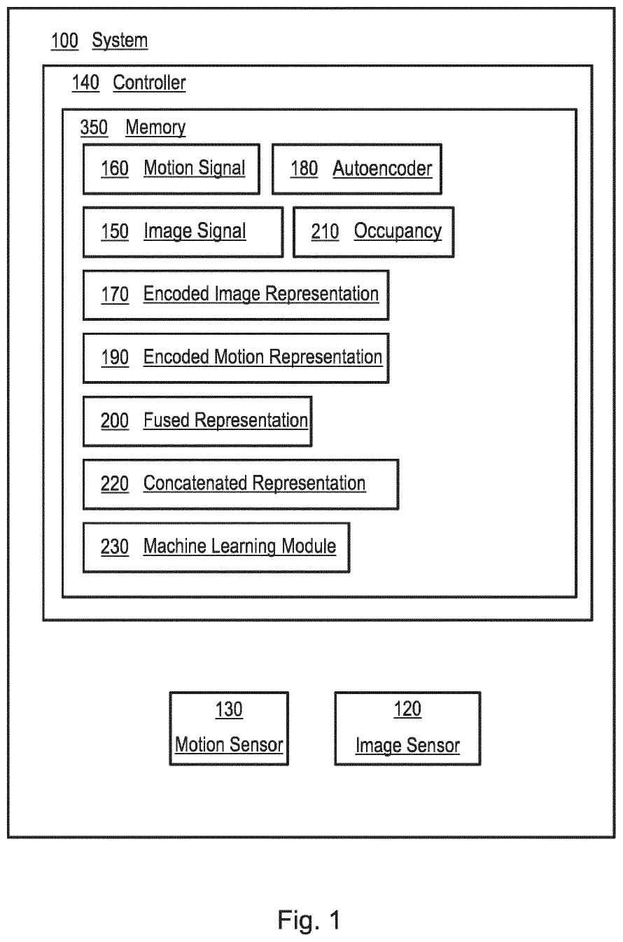

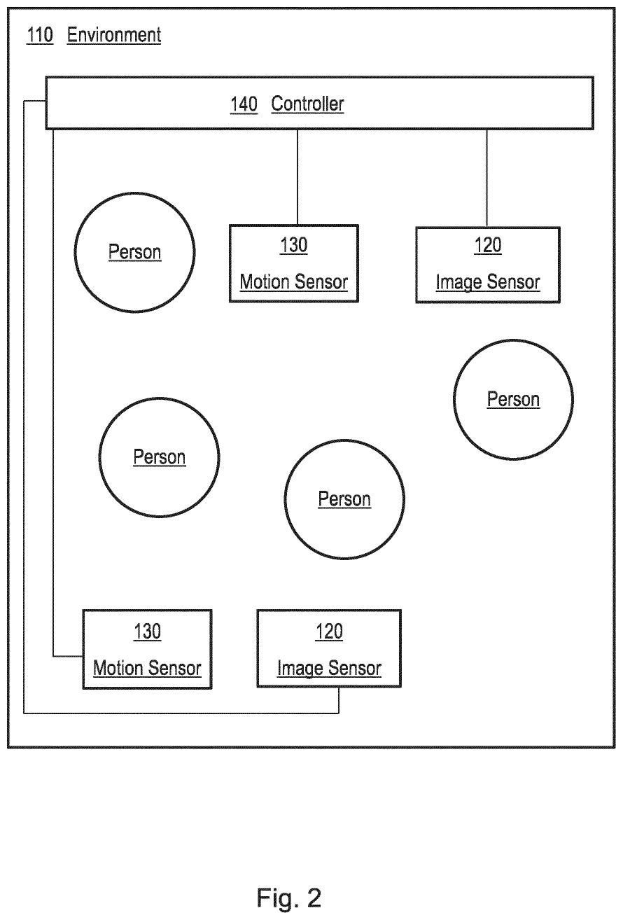

Referring to FIGS. 1 and 2, in one aspect, a system 100 for determining an occupancy 210 of an environment 110 is provided. The environment 110 may be an indoor or outdoor area for which it would be advantageous to determine occupancy. In one example, the environment 110 may be an individual office in an office building. The system 100 may be electrically connected to a lighting system for the environment 110. The lighting system may be responsive to occupancy of the environment 110. In some examples, the lighting system may dim or deactivate one or more luminaires in low occupancy cases. In other examples, the lighting system may brighten or activate one or more luminaires in high occupancy cases.

The system 100 may include one or more image sensors 120. The image sensors 120 may be configured to generate an image signal 150. The image signal 150 may be an electronic representation of one or more persons within fields of view of the image sensors 120. At least one of the image sensors 120 may be an MPT array. The MPT arrays may be used to generate an image signal 150 in terms of temperature, as the temperature measured by each MPT array noticeably increases, or “steps up” when one or more persons are within the field of view of the MPT array. An array of the captured temperatures may then be processed to generate the image signal 150.

In another example, at least one of the image sensors 120 may be a camera. The cameras may be used to generate an image signal 150 in terms of optical data.

In other examples, the image sensors 120 may be any sensors or plurality of sensors, passive or active, capable of detecting presence. In some examples, the image sensors 120 will be positioned in an office to capture images of one or more persons within the office. The image sensors 120 may be configured to transmit the image signals 120.

The system 100 may include one or more motion sensors 130. The motion sensors 130 may be configured to generate a motion signal 160. The motion signal 160 may be an electronic representation of movement of one or more persons within fields of view of the motion sensors 130. At least one of the motion sensors 130 may be a passive PIR sensor. In other examples, the motion sensors 130 may be any sensors or plurality of sensors, passive or active, capable of detecting motion. In some examples, the motion sensors 130 will be positioned in an office to detect motion of one or more persons within the office. The motion signals 160 may include data designating each detected motion as a “minor”, “medium”, or “major” motion. The motion sensors 130 may be configured to transmit the motion signals 160.

The system 100 may include a controller 140. The controller 140 may include a memory 350 and a processor. The controller 140 may be in communication with the image sensor 120 and the motion sensor 130. The communication may be wired and/or wireless, depending on the application. The controller 140 may be configured to receive the image signals 150 transmitted by the image sensors 120. Similarly, the controller 140 may be configured to receive the motion signals 160 transmitted by the motion sensors 130.

The controller 140 may be configured to generate an encoded image representation 170 by encoding the image signal 150 based on an autoencoder 180. An autoencoder is a neural network configured to learn succinct (or “compressed”) representations of input data. An autoencoder is typically comprised of an encoder and a decoder. The encoder processes the input data to a compressed representation. The compressed representation is several orders of magnitude smaller than the input data. The decoder processes the compressed representation into a reconstruction of the original input. The encoder and decoder each entail a simple series of matrix multiplications easily implemented using lightweight microprocessors. Due to the compression of the encoder, the reconstruction will typically contain less data than the input, but, ideally, will approximate the original input to a degree suitable for further processing and/or transmission. Processing and/or transmitting the reconstruction rather than the original input may save significant processing time and power.

In a preferred embodiment, the encoder of the autoencoder 180 is disconnected from the decoder, such that the autoencoder 180 simply outputs the compressed representation of the input, rather than a reconstruction, for subsequent processing. Accordingly, the encoded image representation 170 may be a compressed representation of the image signal 150 according to the encoder portion of the autoencoder 180. Similarly, the controller 140 may be further configured to generate an encoded motion representation 190 by encoding the motion signal 160 based on the autoencoder 180. The encoded image representation 190 may be a compressed representation of the motion signal 160 according to the encoder portion of the autoencoder 180.

The controller 140 may be further configured to adjust, or “train” the autoencoder 180 with the image signal 150. In training, the autoencoder 180 recursively compresses and reconstructs the input signal (such as image signal 150) while optimizing its encoding algorithm to minimize differences between the input signal and the reconstruction. Alternatively, the controller 140 may be further configured to train the autoencoder 180 with the motion signal 160. In other examples, the controller 140 may be further configured to train the autoencoder 180 with both the image signal 150 and the motion signal 160.

The controller 140 may be further configured to generate a fused representation 200 based on the encoded image representation 170 and the encoded motion representation 190. The fused representation combines the data captured by the sensors and encoded by the autoencoder 180 into a single dataset for occupancy calculation. The fused representation 200 may be generated by concatenation and/or cascaded encoding.

In one example, the controller 140 may be further configured to generate the fused representation 200 by concatenating the encoded image representation 170 with the encoded motion representation 190. In this concatenation step, the data of the encoded image representation 170 is sequentially combined with the data of the encoded motion representation to form the fused representation 200.

In another example, the controller 140 may be configured to generate the fused representation 200 by generating a concatenated representation 220 by concatenating the encoded image representation 170 with the encoded motion representation 190 and encoding the concatenated representation 220 based on the autoencoder 180. In other words, this example first separately encodes the image signal 150 and the motion signal 160, then combines the encoded signals via concatenation, and then encodes the result of the concatenation to generate the fused representation. This second layer of encoding may provide a more compressed fused representation 200 than simply concatenating the encoded image representation 170 with the encoded motion representation 190. A more compressed fused representation 200 may be desirable in certain implementations, such as edge computing. However, the second layer of encoding requires additional processing time and power by the controller 140, which may not be desirable in other implementations. If further compression is desired, the controller 140 may add additional encoding layers. In some examples, the secondary encoding layers may implement an autoencoder configured differently than the autoencoder which encoded the image signal 150 and motion signal 160.

The controller 140 may be further configured to determine the occupancy 210 of the environment 110 based on the fused representation 200. The occupancy 210 may be a count of the number of persons present in the environment 110. For example, the occupancy 210 of the environment 110 shown in FIG. 2 would be four (4).

The occupancy 210 of the environment 110 may be determined by applying the fused representation 200 to a machine learning module 230. The machine learning module 230 may determine the occupancy 210 by correlating the fused representation 200 to a plurality of stored representations of known occupancy. For example, if the fused representation 200 most closely correlates to a representation of occupancy of ten (10) persons, the controller 140 determines the occupancy 210 of the environment 110 to be ten (10) persons. Further the controller 140 may update the machine learning module 230 upon the machine learning module 230 making an accurate or inaccurate determination of occupancy 210. The machine learning module 230 may be a decision tree module. The decision tree module may be configured to implement a decision tree algorithm to perform the correlation described above. Alternatively, the machine learning module may implement a logistic regression algorithm or linear regression algorithm to perform the correlation.

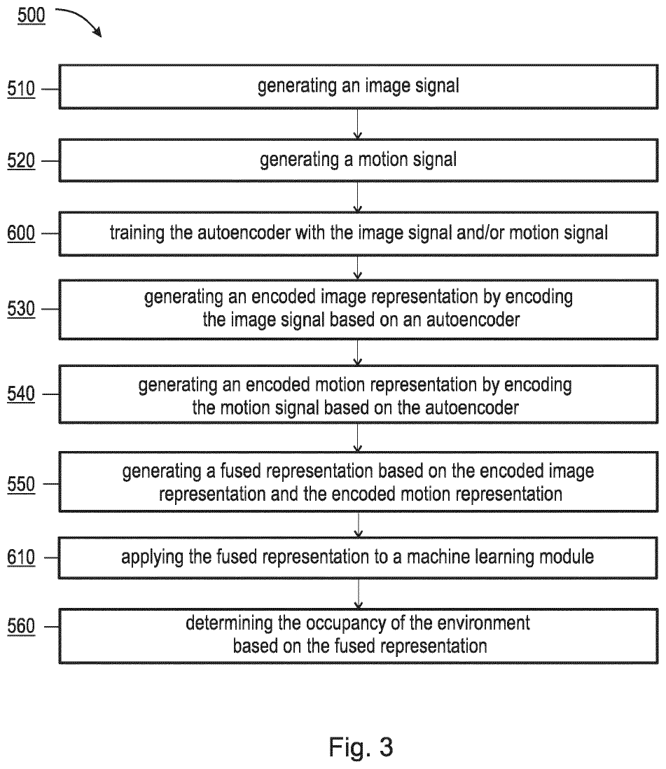

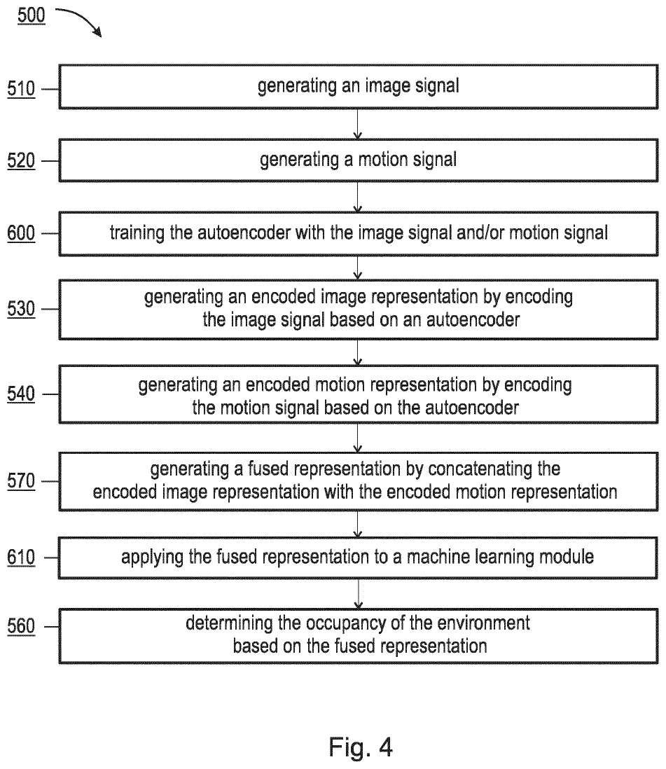

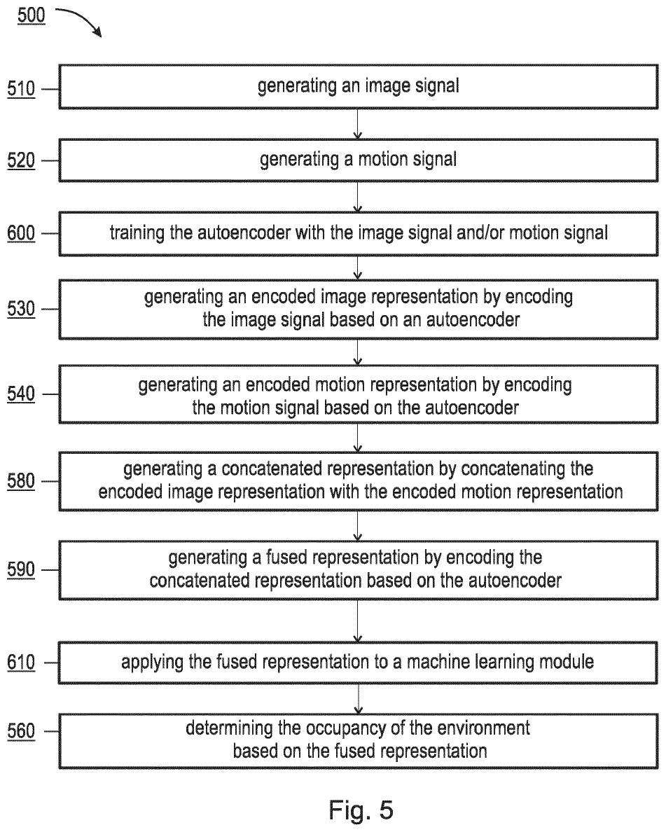

Referring to FIGS. 3-5, in another aspect, a method 500 for determining an occupancy of an environment is provided. The method 500 may include generating 510, via one or more image sensors, an image signal. The method 500 may further include generating 520, via one or more motion sensors, a motion signal.

The method 500 may further include generating 530, via a controller, an encoded image representation by encoding the image signal based on an autoencoder. The method 500 may further include generating 540, via the controller, an encoded motion representation by encoding the motion signal based on the autoencoder.

The method 500 may further include training 600, via the controller, the autoencoder with the image signal and/or motion signal.

The method 500 may further include generating 550, via the controller, a fused representation based on the encoded image representation and the encoded motion representation. In one example, the fused representation may be generated by concatenating 570, via the controller, the encoded image representation with the encoded motion representation.

In another example, the fused representation may be generated by generating 580, via the controller, a concatenated representation by concatenating the encoded image representation with the encoded motion representation, and encoding 590, via the controller, the concatenated representation based on the autoencoder.

The method may further include determining 560, via the controller, the occupancy of the environment based on the fused representation. The occupancy of the environment may be determined by applying 610 the fused representation to a machine learning module. The machine learning module may be a decision tree module.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

1. A system for determining an occupancy of an environment, comprising:
one or more image sensors configured to generate an image signal;
one or more motion sensors configured to generate a motion signal; and
a controller in communication with the image sensor and the motion sensor, the controller configured to:
generate an encoded image representation by encoding the image signal based on an autoencoder;
generate an encoded motion representation by encoding the motion signal based on the autoencoder;
generate a fused representation based on the encoded image representation and the encoded motion representation, wherein the fused representation is generated by at least one of concatenating the encoded image representation with the encoded motion representation and cascading the encoded image representation with the encoded motion representation; and
determine the occupancy of the environment based on the fused representation by correlating the fused representation to a plurality of stored representations of known occupancy.

2. The system of claim 1, wherein the controller is further configured to generate the fused representation by:
encoding the fused representation based on the autoencoder.

3. The system of claim 1, wherein the controller is further configured to train the autoencoder with the image signal and/or motion signal.

4. The system of claim 1, wherein at least one of the motion sensors is a passive infrared sensor.

5. The system of claim 1, wherein at least one of the image sensors is a multi-pixel thermopile array.

6. The system of claim 1, wherein at least one of the image sensors is a camera.

7. The system of claim 1, wherein the occupancy of the environment is determined by applying the fused representation to a machine learning module.

8. The system of claim 7, wherein the machine learning module is a decision tree module.

9. A method for determining an occupancy of an environment, comprising:
generating, via one or more image sensors, an image signal;
generating, via one or more motion sensors, a motion signal;
generating, via a controller, an encoded image representation by encoding the image signal based on an autoencoder;
generating, via the controller, an encoded motion representation by encoding the motion signal based on the autoencoder;
generating, via the controller, a fused representation based on the encoded image representation and the encoded motion representation, wherein the fused representation is generated by at least one of concatenating the encoded image representation with the encoded motion representation and cascading the encoded image representation with the encoded motion representation; and
determining, via the controller, the occupancy of the environment based on the fused representation by correlating the fused representation to a plurality of stored representations of known occupancy.

10. The method of claim 9, wherein the fused representation is further generated by:
encoding, via the controller, the fused representation based on the autoencoder.

11. The method of claim 9, further comprising training, via the controller, the autoencoder with the image signal and/or motion signal.

12. The method system of claim 9, wherein the occupancy of the environment is determined by applying the fused representation to a machine learning module.

13. The method system of claim 12, wherein the machine learning module is a decision tree module.
